(19) United States
(12) Patent Application Publication
(10) Pub. No.: US 2026/0191166 A1
(43) Pub. Date: Jul. 9, 2026

(54) ANIMAL CLIMBING STRUCTURE FOR FEED TROUGH

(71) Applicant: Kathryn Lynne Krysh, Trout Valley, IL (US)

(72) Inventor: Kathryn Lynne Krysh, Trout Valley, IL (US)

(21) Appl. No.: 19/443,129

(22) Filed: Jan. 8, 2026

Related U.S. Application Data
(60) Provisional application No. 63/743,286, filed on Jan. 9, 2025.

(51) Int. Cl. A01K 5/01; A01K 29/00

(52) U.S. Cl. CPC A01K 5/01; A01K 29/00

(57) ABSTRACT

An animal escape structure for use with an animal feeding trough. The structure includes a rigid climbing member mountable to an upper portion of the feeding trough. The climbing member includes a vertically elongated panel having a plurality of spaced openings formed therethrough to provide footholds or handholds for small animals. When mounted, the panel extends downwardly into an interior of the feeding trough, enabling a small animal located within the trough to climb upwardly along the panel and exit the trough.

### CROSS-REFERENCE TO RELATED APPLICATION

This application claims priority to and the benefit of the filing date of U.S. Provisional Patent Application Ser. No. 63/743,286 filed Jan. 9, 2025, entitled “Animal Climbing Structure for Feed Trough,” the entirety of which is hereby incorporated by reference as if set forth fully herein.

### FIELD OF INVENTION

Embodiments presented herein are directed to a structure for an animal feeding trough, and more particularly to a structure to enable small animals to crawl up an out of a trough to escape from getting trapped or drowned within the trough and the food/liquid contents supplied to farm animals.

### BACKGROUND

In the field of animal farming it is common for farm animals to receive nourishment through a feeding trough. Conventionally, animal feeding troughs have an open top to enable the farm animals to access the food supply or liquid contents received in the trough. Unfortunately, the food or liquid contents within a feeding trough can attract other unintended small animals such a such as rodents or reptiles, and the open top of the trough can enable such smaller animals to access the trough contents. In many instances, the depth of a feeding trough can exceed the height of such smaller animals and the interior surfaces of the trough can be substantially smooth and vertical. Thus, occasionally, such smaller animals can fall into the trough and be unable to readily escape getting trapped within the food or liquid contents. Such situation can cause such smaller animals to die within the trough which can contaminate the food supply or liquid contents being provided to the farm animals. When such situation arises, the farm animals receiving nourishment from the trough can contract illnesses or diseases which can adversely impact the animal's well-being and ability to produce viable product. As such, there is a need in the art for a solution that can provide smaller animals that get caught in a food trough with a means for escape to avoid contamination of the nourishment for the farm animals.

### BRIEF DESCRIPTION OF THE DRAWINGS

FIG. 1A is a front elevation view of the structure according to embodiments presented herein.

FIG. 1B is a side elevation view of the structure according to embodiments presented herein.

FIG. 1C is a top plan view of the structure according to embodiments presented herein.

FIG. 2 is a front elevation view of a plate for forming the structure and a table specifying information for bending portions of said plate according to embodiments presented herein.

FIG. 3 is a perspective view of the structure according to embodiments presented herein.

### DETAILED DESCRIPTION

The following description of the invention references specific embodiments in which the invention can be practiced. The embodiments are intended to describe aspects of the invention in sufficient detail to enable those skilled in the art to practice the invention. Other embodiments can be utilized, and changes can be made, without departing from the scope of the present invention.

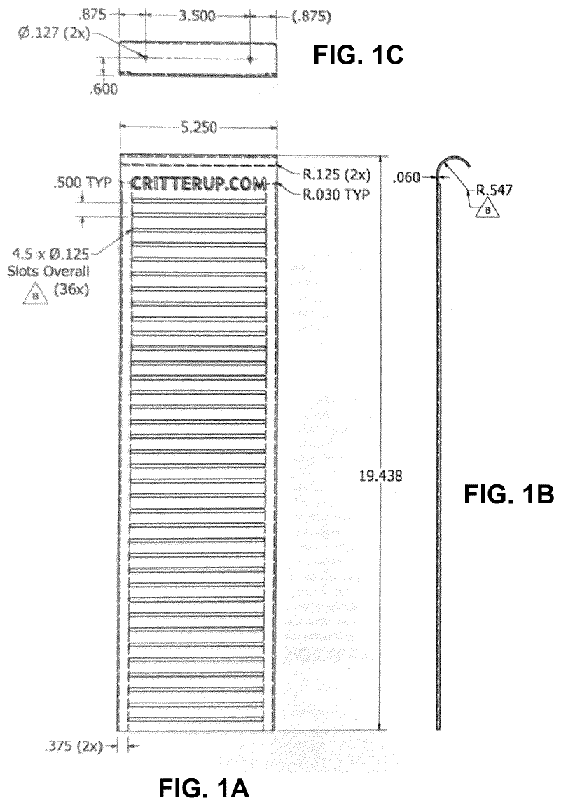

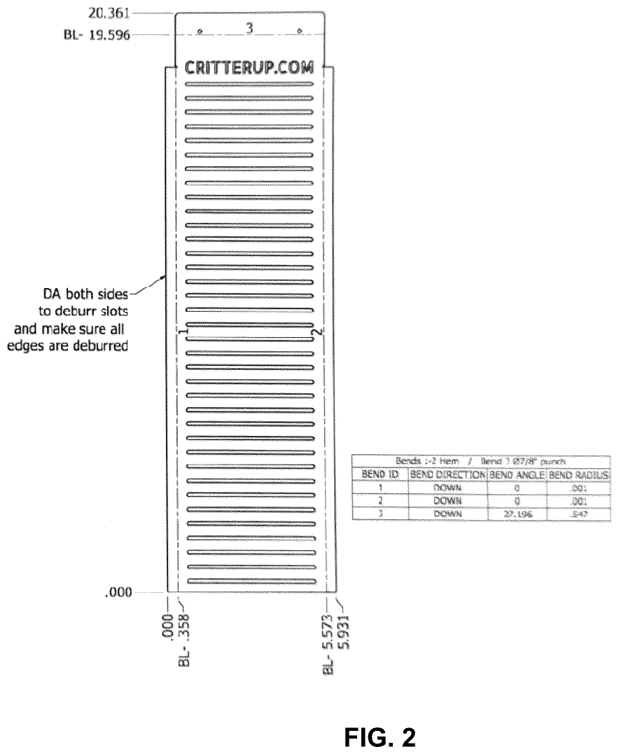

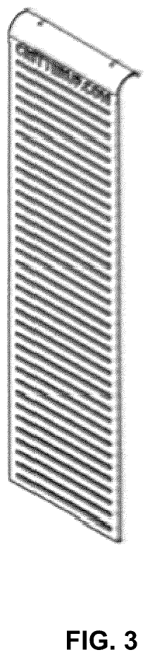

According to representative embodiments illustrated in FIGS. 1 through 3, there is shown a representative animal climbing structure for use with a feeding trough according to embodiments presented herein. As shown schematically in FIGS. 1 through 3, the structure can be comprised of a plate that can be formed into a climbing structure including a substantially flat panel segment having a bent or curved top segment and folded side segments. The flat panel segment can have an elongated orientation in a vertical direction and a plurality of parallel elongated openings or slots in vertical alignment along the flat panel. The slots can have a width on the order of 4.5″ and a length on the order of 0.125″. The slots can be spaced apart from one another on the order of about 0.500″. The climbing structure can be made of metal or other rigid material. The curved top segment can bend in a direction over the rear surface of the flat panel at a curve on the order of 0.547″ and include two spaced-apart openings extending therethrough. The opening can be configured for receiving fasteners such as screws for securing the top portion of the climbing structure to a portion of a trough.

According to representative embodiments presented herein, the climbing structure can have a height in the range of 17-20″ and upon being secured to a trough, the flat panel segment can extend downward from the top curved segment into a portion of the trough through trough's open top. Thus, in use, the elongated horizontal slots along the flat panel segment can be utilized as rungs or steps so as to enable small animals such as rodents or reptiles to grasp or gain a footing along the vertical panel segment. Thus, persons of ordinary skill in the art will recognize that the slots along the panel assembly can serve as a climbing structure in the nature of a ladder to enable such smaller animals to climb and escape from getting trapped under or drowned in food or liquid contents received within the trough.

Embodiments presented herein are most useful to prevent smaller animals from getting trapped within a feeding trough which can result in contamination of the food supply or liquid contents being provided to farm animals. Thus, embodiments presented herein can support the well-being of farm animals by preventing such animals from contracting illnesses resulting from contamination of their food supply from smaller animals that get trapped in the feed trough.

What is claimed is:

1. An animal escape structure for use with an animal feeding trough, comprising:
a rigid climbing member configured to be mounted to the feeding trough, the climbing member including:
a vertically elongated panel portion;
a plurality of spaced openings formed through the panel portion and arranged to provide footholds or handholds for small animals; and
a mounting portion coupled to the panel portion and configured to secure the climbing member to an upper portion of the feeding trough,
wherein the panel portion is configured to extend downwardly into an interior of the feeding trough such that a small animal located within the trough is enabled to climb upwardly along the panel portion and exit the trough.

2. The animal escape structure of claim 1, wherein the openings are elongated slots arranged substantially horizontally.

3. The animal escape structure of claim 1, wherein the openings are arranged in a vertically spaced, ladder-like configuration.

4. The animal escape structure of claim 1, wherein the panel portion is substantially planar.

5. The animal escape structure of claim 1, wherein the mounting portion comprises a curved or bent segment extending over an edge of the feeding trough.

6. The animal escape structure of claim 5, wherein the mounting portion includes at least one fastener opening configured to receive a mechanical fastener.

7. The animal escape structure of claim 1, wherein the panel portion has a vertical height sufficient to extend below a food or liquid level within the trough during normal use.

8. The animal escape structure of claim 1, wherein the climbing member is formed from metal, polymer, composite material, or combinations thereof.

9. The animal escape structure of claim 1, further comprising stiffening portions extending along lateral edges of the panel portion.

10. The animal escape structure of claim 1, wherein the openings are sized to permit gripping by rodents or reptiles.

11. The animal escape structure of claim 1, wherein the climbing member is removably attachable to the feeding trough.

12. A method of preventing contamination of an animal feeding trough, comprising: mounting an animal escape structure to an upper portion of the feeding trough;
extending a vertically elongated panel portion of the escape structure downwardly into an interior of the feeding trough; and
providing a plurality of spaced openings along the panel portion that enable a small animal located within the trough to climb upwardly and escape the trough, thereby reducing the likelihood that the small animal becomes trapped or drowned within the trough.

13. The method of claim 12, wherein mounting the animal escape structure includes fastening a curved mounting portion to a rim of the feeding trough.

14. The method of claim 12, wherein the spaced openings are arranged to function as rungs of a ladder.

15. The method of claim 12, wherein the panel portion extends below a level of food or liquid contained within the feeding trough.

16. The method of claim 12, wherein the small animal includes a rodent or reptile.

17. An animal feeding system, comprising:
an animal feeding trough defining an interior cavity; and
an animal escape structure secured to the feeding trough, the escape structure including: a vertically oriented panel portion extending into the interior cavity; and
a plurality of spaced openings formed through the panel portion and configured to permit climbing by small animals,
wherein the escape structure enables small animals that enter the feeding trough to exit the feeding trough without assistance.

18. The animal feeding system of claim 17, wherein the feeding trough includes substantially smooth interior wall surfaces.

19. The animal feeding system of claim 17, wherein the animal escape structure is positioned adjacent an open top of the feeding trough.

20. The animal feeding system of claim 17, wherein the animal escape structure is detachably mounted to the feeding trough using mechanical fasteners.
